(19) United States
(12) Patent Application Publication
(10) Pub. No.: US 2015/0362003 A1
(43) Pub. Date: Dec. 17, 2015

(54) ROTARY FASTENER

(71) Applicant: HANWIT PRECISION INDUSTRIES LTD., New Taipei City (TW)

(72) Inventor: Ying-Chih TSENG, New Taipei City (TW)

(21) Appl. No.: 14/306,955

(22) Filed: Jun. 17, 2014

(51) Int. Cl. F16B 5/02; F16B 39/22

(52) U.S. Cl. CPC F16B 5/0266; F16B 39/22

(57) ABSTRACT

A rotary fastener includes a base member, a holder member fixedly mounted in said base member, an axle member axially movably mounted in said holder member, a cap member affixed to the top end of the axle member above the holder member, a spring member mounted around the axle member and adapted to impart a downward pressure to the axle member relative to the holder member, a socket member affixed to the cap member, and two mating curved tracks respectively formed integral with the base member and the socket member and matched with each other and movable relative to each other to shift the axle member between a locking position to lock the first panel member to a second panel member and an unlocking position to unlock the first panel member from the second panel upon rotation of the base member relative to the socket member.

### BACKGROUND OF THE INVENTION

1. Field of the Invention

The present invention relates to fastener means for detachably securing two panel members together and more particularly, to a rotary fastener, which uses two matched curved tracks to control axial displacement of an axle member between a locking position and an unlocking position when the user rotate a base member that carries one curved track relative to a socket member that carries the other cured track.

2. Description of the Related Art

Screws and pins are widely used in drawers, machines and many other retractable devices for temporarily locking a movable member to a fixed member in a predetermined operating position. Further, in a desk computer, notebook computer, industrial computer or workstation that consists of multiple devices or mechanisms, screws or pins may be used to detachably lock one first panel member to a second panel member. Unlocking these screws or pins allow separation of the first panel member and the second panel member.

However, mounting or dismounting the screws or pins, the users hand can easily be injured by the points or threads of the screws or pins. Further, the screws or pins can get lost easily after dismounted. If some screws or pins get lost, the assembled structure may be unstable. Further, a proper hand tool must be used when mounting or dismounting the screws or pins. If a proper hand tool is not available, the mounting or dismounting work will be interrupted, causing inconvenience.

In order to eliminate the aforesaid problems, rotary fasteners are created. FIGS. 11 and 12 illustrate a rotary fastener for use to lock panel members together. As illustrated, this design of rotary fastener comprises a base member A, which comprises an axial through hole A0 extended from opposing top and bottom sides thereof and a recessed accommodation chamber A1 located in the top side, and a locking device B inserted through the axial through hole A0 of the base member A. The locking device B comprises a locking pin B1, a compression spring B2, a position-limit member B3, and an operating knob B4. The locking pin B1 comprises a pin body B13, a bottom locking block B11 located at a bottom end of the pin body B13, a stop flange B12 extending around the periphery of the pin body B13 adjacent to the bottom locking block B11, a locating groove B15 extending around the periphery of the pin body B13 and spaced above the stop flange B12, two cut planes B14 bilaterally located on the periphery of the pin body B13, and a screw hole B16 located in an opposing top end of the pin body B13 remote from the bottom locking block B11. The compression spring B2 is sleeved onto the locking pin B1 and stopped between the stop flange B12 and the position-limit member B3. The position-limit member B3 is fixedly mounted in the recessed accommodation chamber A1 of the base member A, comprising an oblong position-limit hole B30 cut through opposing top and bottom sides thereof and two cut planes B1 located in the oblong position-limit hole B30 and respectively abutted against the cut planes B14. The operating knob B4 is disposed above the base member A, comprising a bottom screw rod B41 threaded into the screw hole B16 of the locking pin B1. The user can pull the operating knob B4 to lift the locking pin B1 and to compress the compression spring B2, enabling the bottom locking block B11 to be received in the axial through hole A0 inside the base member A. When the locking pin B1 reaches the position where the locating groove B15 is kept in horizontal alignment with the position-limit member B3, the user can rotate the operating knob B4 and the locking pin B1 to move the two cut planes B14 of the locking pin B1 away from the two cut planes B1 of the position-limit member B3, enabling the pin body B13 of the locking pin B1 to be temporarily locked to the position-limit member B3 in the received (unlocking) position. When rotating the operating knob B4 relative to the position-limit member B3 and the base member A to have the two cut planes B14 of the locking pin B1 face toward the two cut planes B1 of the position-limit member B3 and then release the force from operating knob B4, the compression spring B2 immediately pushes the locking pin B1 from the received (unlocking position) back to the extended (locking position) to suspend the bottom locking block B11 outside the axial through hole A0 of the base member A.

According to the aforesaid prior art rotary fastener, the position-limit member B3 is fixedly mounted in the recessed accommodation chamber A1 of the base member A, thus, the user cannot easily view the relative position between the two cut planes B14 of the locking pin B1 face toward the two cut planes B1 of the position-limit member B3, making the operation difficult. Further, when pulling the operating knob B4 to lift the locking pin B1 relative to the position-limit member B3 and the base member A, the compression spring B2 imparts a resistance to the operating knob B4, causing the user unable to keep the locking pin B1 in balance, and the locking pin B1 can be accidentally forced by the compression spring B2 toward the outside of the axial through hole A0 of the base member A, causing the operating knob B4 to strike against the position-limit member B3 and the base member A. Therefore, there is a strong demand for a rotary fastener that eliminates the drawbacks of the aforesaid prior art design.

### SUMMARY OF THE INVENTION

The present invention has been accomplished under the circumstances in view. It is therefore the main object of the present invention to provide a rotary fastener for locking two panel members together, which has the advantages of ease of use, high installation reliability and high positioning accuracy.

To achieve this and other objects of the present invention, a rotary fastener in accordance with the present invention comprises a base member, a holder member fixedly mounted in said base member and affixed to a first panel member, an axle member axially movably mounted in said holder member, a cap member affixed to the top end of the axle member above the holder member, a spring member mounted around the axle member and adapted to impart a downward pressure to the axle member relative to the holder member, a socket member affixed to the cap member, and two mating curved tracks respectively formed integral with the base member and the socket member and matched with each other and movable relative to each other to shift the axle member between a locking position to lock the first panel member to a second panel member and an unlocking position to unlock the first panel member from the second panel upon rotation of the base member relative to the socket member.

Further, the base member comprises at least one finger rod extended from the periphery thereof, and a retaining groove defined in each finger rod. Further, the socket member comprises at least one locating block perpendicularly extended from the periphery thereof and detachably positionable in the retaining groove in each finger rod of the base member.

Further, each curved track comprises two opposite lifting portions, two homing grooves equiangularly spaced between the lifting portions at two opposite sides, two sloping guide surfaces respectively downwardly extended from respective one ends of the lifting portions to respective one ends of the homing grooves, and two upright stop edges respectively connected between respective opposite ends of the lifting portions and respective opposite ends of the sloping guide surfaces.

### BRIEF DESCRIPTION OF THE DRAWINGS

FIG. 1 is an oblique top elevational view of a rotary fastener in accordance with a first embodiment of the present invention.

FIG. 2 is an exploded view of the rotary fastener in accordance with the first embodiment of the present invention.

FIG. 3 corresponds to FIG. 2 when viewed from another angle.

FIG. 4 is a sectional side view of the rotary fastener in accordance with the first embodiment of the present invention.

FIG. 5 is a schematic sectional applied view of the first embodiment of the present invention, illustrating the rotary fastener installed in a first panel member and the axle member locked to a second panel member.

FIG. 6 is an elevational view of the first embodiment of the present invention, illustrating the rotary fastener in the unlocking position.

FIG. 7 is an oblique top elevational view illustrating a rotary fastener in accordance with a second embodiment of the present invention installed in a first panel member and locked to a second panel member.

FIG. 8 is a sectional side view of FIG. 7.

FIG. 9 is an oblique top elevational view illustrating a rotary fastener in accordance with a third embodiment of the present invention installed in a first panel member and locked to a second panel member.

FIG. 10 is a sectional side view of FIG. 9.

FIG. 11 is an exploded view of a rotary fastener according to the prior art.

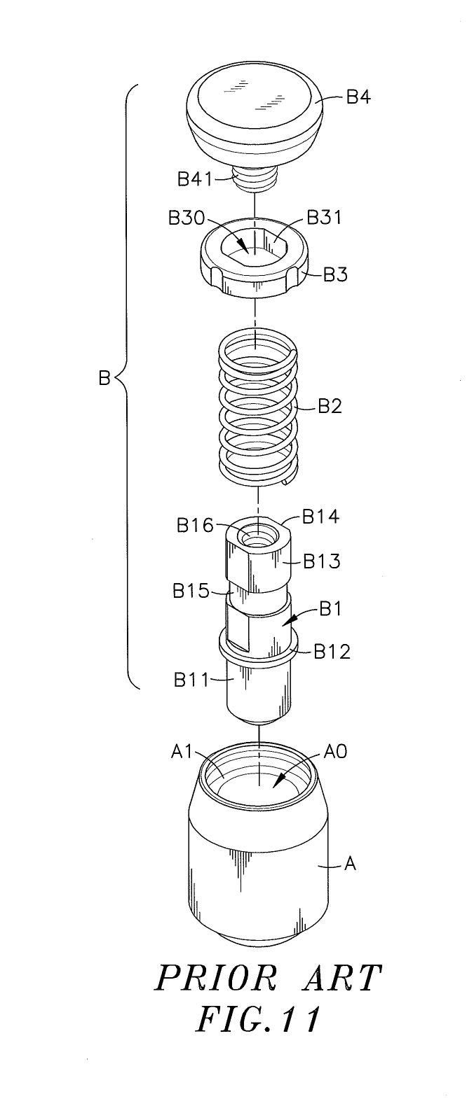

FIG. 12 is a sectional applied view of the rotary fastener according to the prior art.

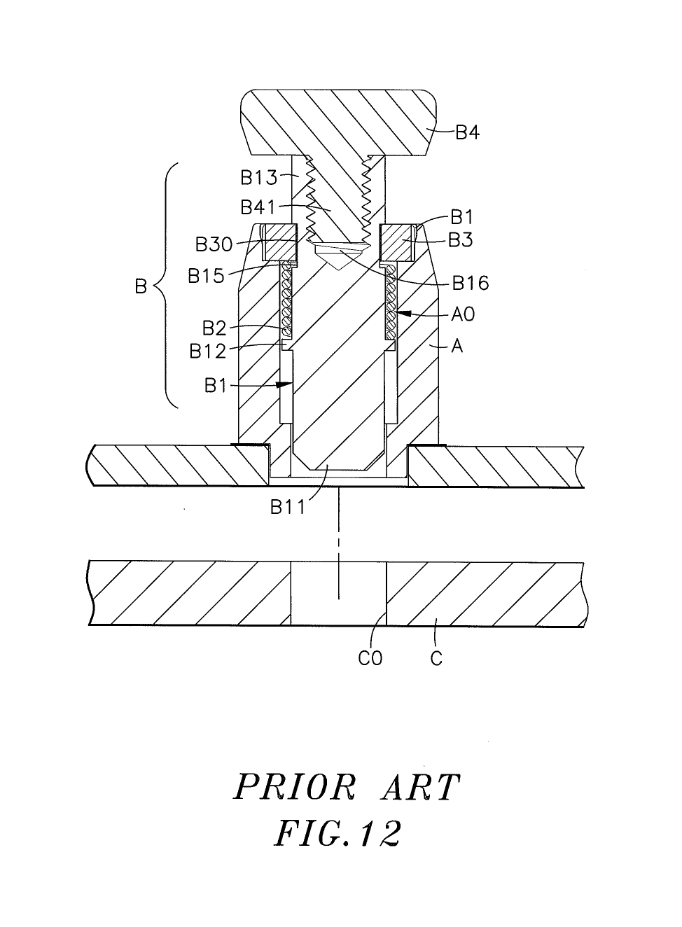

### DETAILED DESCRIPTION OF THE PREFERRED EMBODIMENT

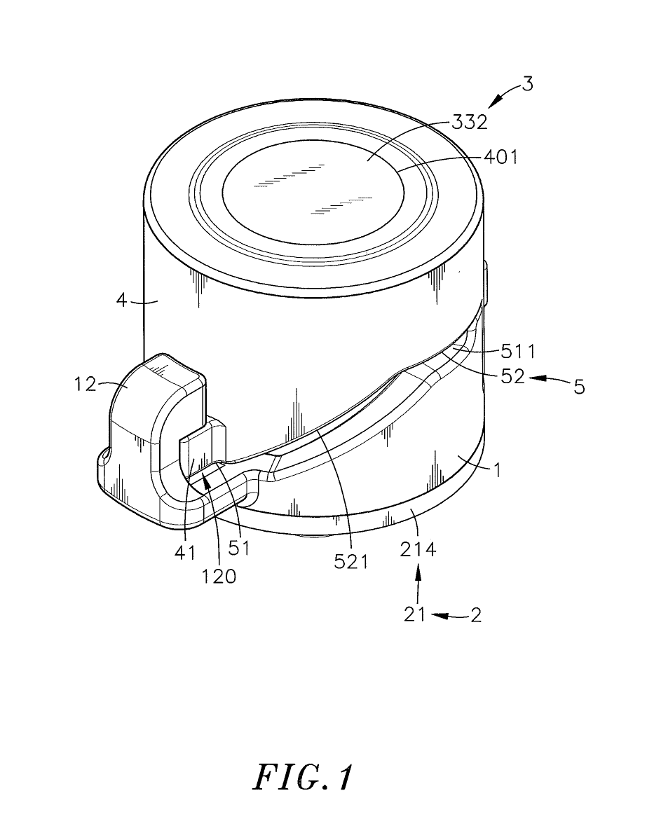

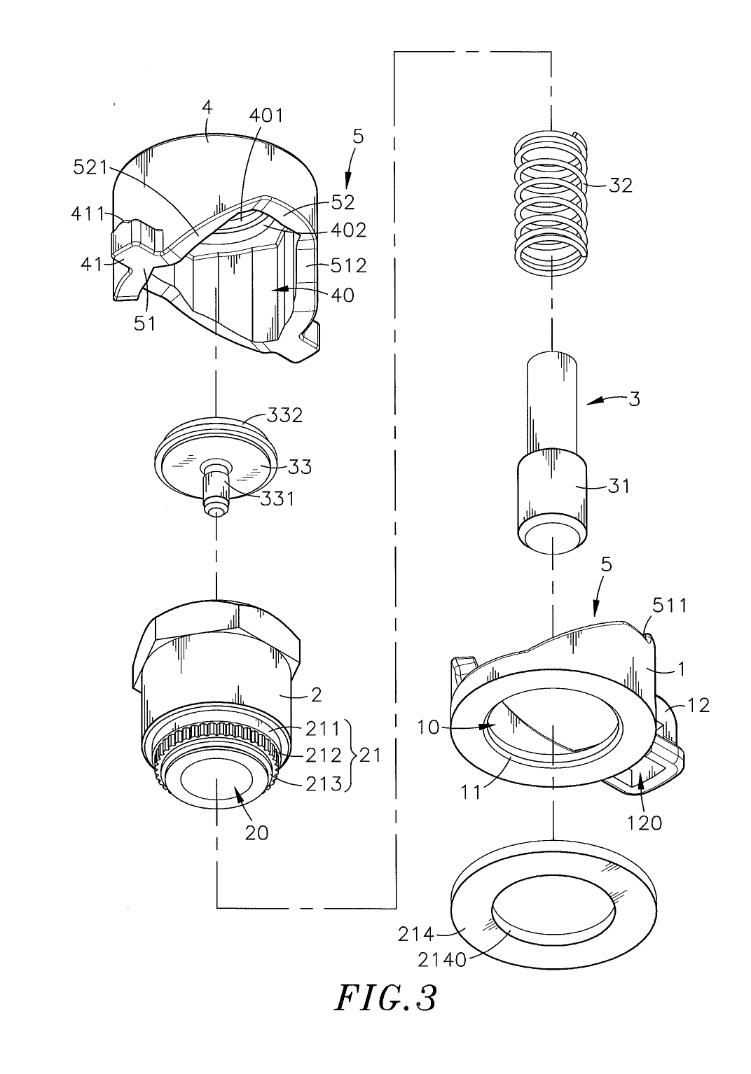

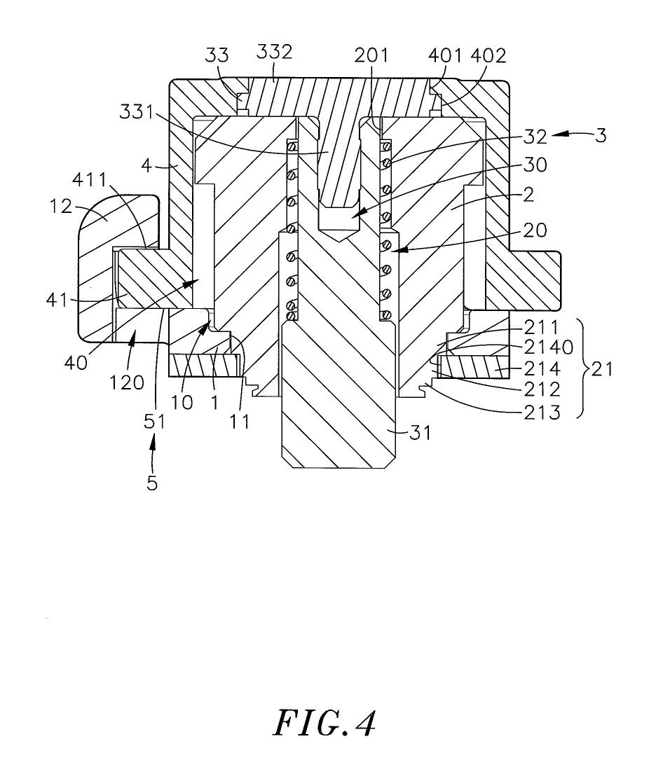

Referring to FIGS. 1-4, a rotary fastener in accordance with a first embodiment of the present invention is shown. The rotary fastener comprises a base member 1, a holder member 2, a cushion ring 214, an axle member 3, a cap member 33, a spring member 32, a socket member 4, and two mating curved tracks 5.

The base member 1 comprises an accommodation open chamber 10, an axial center hole 11 cut through a bottom wall thereof in communication with the accommodation open chamber 10, a finger rod 12 extended from the periphery thereof, and a retaining groove 120 defined between the finger rod 12 and the periphery of the base member 1.

The holder member 2 comprises a bottom-open chamber 20, a center axle hole 201 located in a top wall thereof in communication with the bottom-open chamber 20, and a stepped, tubular bottom mounting neck 21 axially downwardly extended from an opposing bottom edge thereof and defining an upper coupling ring portion 211, an intermediate engagement ring portion 212 and a lower mating connection ring portion 213. Further, the cushion ring 214 is mounted around the intermediate engagement ring portion 212 of the stepped, tubular bottom mounting neck 21 of the holder member 2, having an inner perimeter 2140 forced into engagement with the intermediate engagement ring portion 212.

The axle member 3 is movably upwardly inserted through the center axle hole 201 of the holder member 2, having an expanded bottom end portion 31 thereof downwardly movable in and out of the stepped, tubular bottom mounting neck 21 of the holder member 2 and a mounting hole 30 located in a top end thereof. The spring member 32 is sleeved onto the axle member 3 and supported on the expanded bottom end portion 31. The cap member 33 is movably disposed above the holder member 2, comprising a bottom mounting rod 331 extended from a bottom side thereof and affixed to the mounting hole 30 of the axle member 3 and a flat top mounting block 332 located at an opposing top side thereof.

The socket member 4 is rotatably and axially movably mounted around the holder member 2, comprising a receiving chamber 40 defined therein and extending through a bottom side thereof, a top opening 401 located in an opposing top side thereof in communication with the receiving chamber 40, a mounting groove 402 defined in a top of the receiving chamber 40 and extending around the top opening 401, and a locating block 41 perpendicularly extended from the periphery thereof. The locating block 41 has a rib 411 of arched cross section located at a top side thereof.

The two mating curved tracks 5 are respectively located at the top side of the base member 1 and the bottom side of the socket member 4 and adapted to match with each other. Each curved track 5 comprises two opposite lifting portions 51, a bearing groove 511 located in each lifting portion 51, two homing grooves 52 equiangularly spaced between the lifting portions 51 at two opposite sides, two sloping guide surfaces 521 respectively downwardly extended from respective one ends of the lifting portions 51 to respective one ends of the homing grooves 52, and two upright stop edges 512 respectively connected between respective opposite ends of the lifting portions 51 and respective opposite ends of the sloping guide surfaces 521.

When assembling the rotary fastener, insert the upper coupling ring portion 211 of the stepped, tubular bottom mounting neck 21 of the holder member 2 axially downwardly into the axial center hole 11 in the accommodation open chamber 10 of the base member 1 to suspend the intermediate engagement ring portion 212 outside the base member 1, and then fasten the cushion ring 214 to the intermediate engagement ring portion 212 of the stepped, tubular bottom mounting neck 21 of the holder member 2, and then upwardly insert the axle member 3 through the spring member 32 and the center axle hole 201 of the holder member 2 to suspend the mounting hole 30 above the holder member 2 and the expanded bottom end portion 31 below the holder member 2 and to let the spring member 32 be stopped between the expanded bottom end portion 31 of the axle member 3 and a bottom surface of the top wall of the holder member 2, and then affix the bottom mounting rod 331 of the cap member 33 to the mounting hole 30 of the axle member, and then attach the socket member 4 to the cap member 33 around the holder member 2 to force the mounting groove 402 into engagement with the cap member 33 and to have the flat top mounting block 332 of the cap member 33 be press-fitted into the top opening 401 of the socket member 4. When assembled, the two opposite lifting portions 51 of the curved track 5 at the base member 1 are respectively rested in the two homing grooves 52 of the curved track 5 at the socket member 4, the two opposite lifting portions 51 of the curved track 5 at the socket member 4 are respectively rested in the two homing grooves 52 of the curved track 5 at the base member 1, and the locating block 41 of the socket member 4 is positioned in the retaining groove 120 in the finger rod 12 of the base member 1.

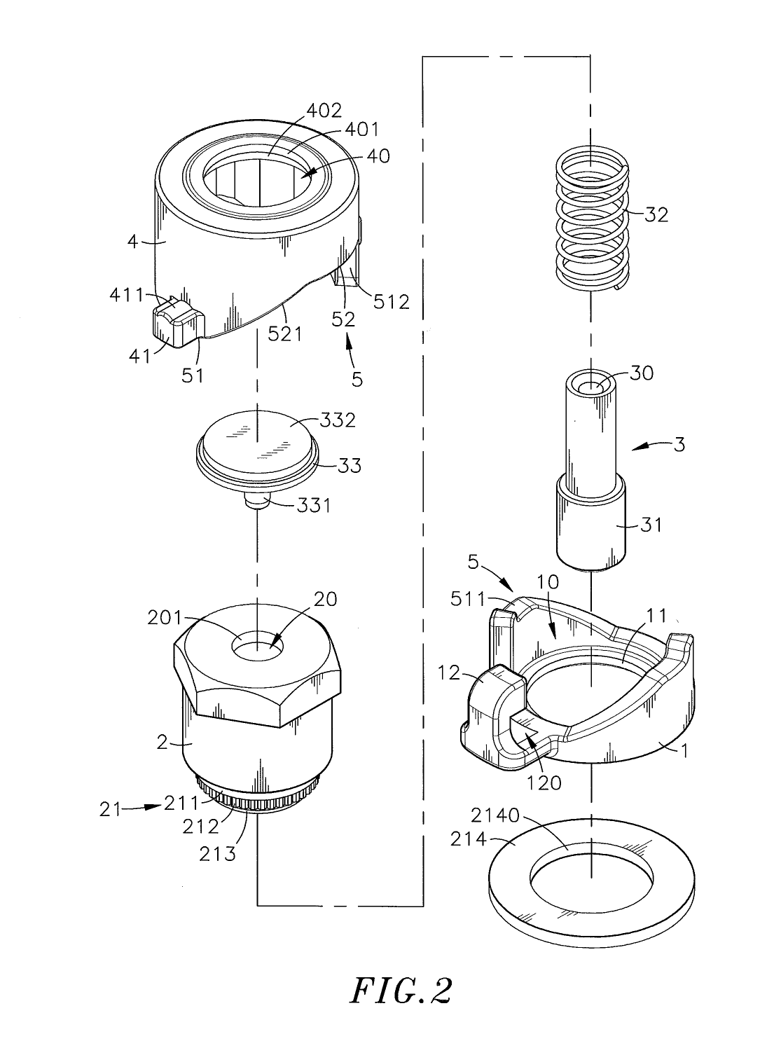

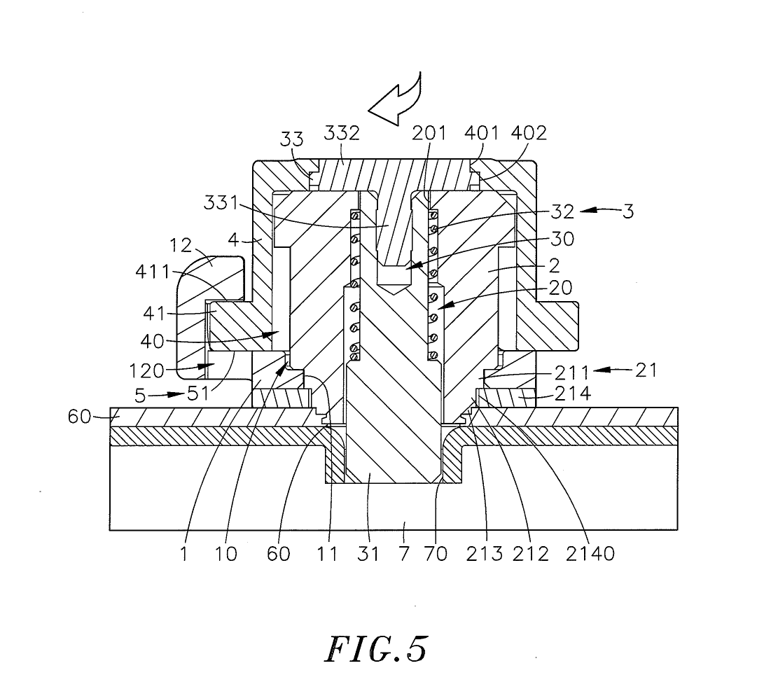

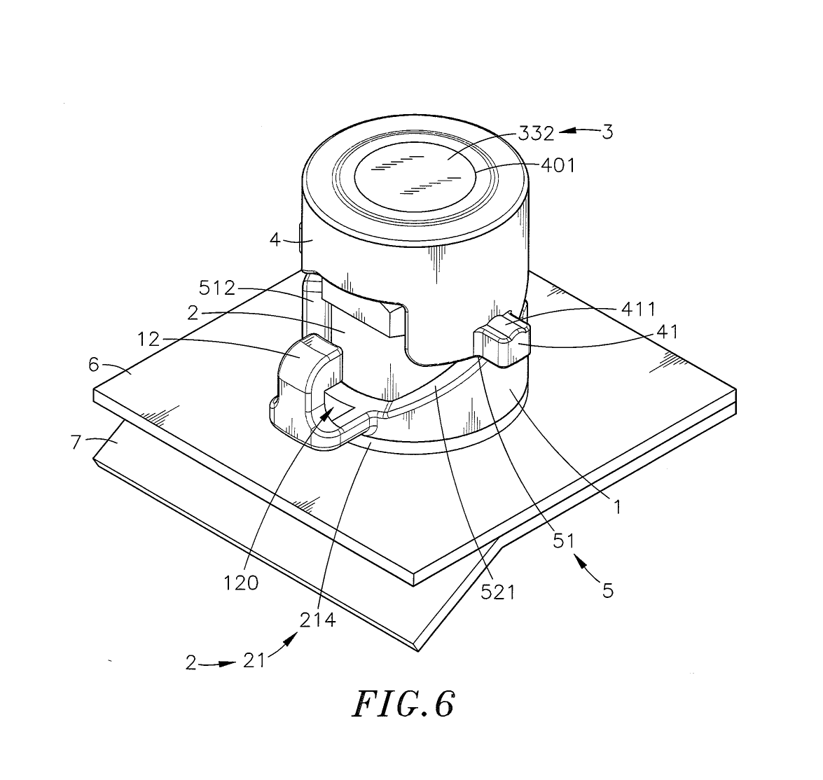

Referring to FIGS. 5 and 6 and FIGS. 2-4 again, in application, the bottom mounting neck 21 of the holder member 2 that extends downwardly out of the bottom side of the axial center hole 11 of the base member 1 is fastened to a mounting through hole 60 in a first panel member 6 that is detachably mounted on a second panel member 7, and the expanded bottom end portion 31 of the axle member 3 is downwardly extended out of the bottom side of the axial center hole 11 of the base member 1 and engaged into a locking hole 70 in the second panel member 7 to lock the first panel member 6 to the second panel member 7.

When wishing to separate the first panel member 6 from the second panel member 7, rotate the finger rod 12 of the base member 1 relative to the socket member 4 to move the curved track 5 at the base member 1 along the curved track 5 at the socket member 4. During rotation of the base member 1 relative to the socket member 4, the two opposite lifting portions 51 of the curved track 5 at the base member 1 are moved out of the two homing grooves 52 of the curved track 5 at the socket member 4 along the two sloping guide surfaces 521 of the curved track 5 at the socket member 4 to the lifting portions 51 of the curved track 5 at the socket member 4, at the same time, the two opposite lifting portions 51 of the curved track 5 at the socket member 4 are moved out of the two homing grooves 52 of the curved track 5 at the base member 1 along the two sloping guide surfaces 521 of the curved track 5 at the base member 1 to the lifting portions 51 of the curved track 5 at the base member 1. At this time, the two opposite lifting portions 51 of the curved track 5 at the socket member 4 are respectively positioned in the bearing grooves 511 of the curved track 5 at the base member 1, the two opposite lifting portions 51 of the curved track 5 at the base member 1 are respectively positioned in the bearing grooves 511 of the curved track 5 at the socket member 4, and the socket member 4 is disposed at a relatively higher elevation to lift the cap member 33 and the axle member 3 relative to the base member 1, and therefore, the spring member 32 is compressed in the bottom open chamber 20 inside the holder member 2, and the expanded bottom end portion 31 of the axle member 3 is disengaged from the locking hole 70 of the second panel member 7 to unlock the first panel member 6 from the second panel member 7. When rotating the base member 1 to lift the socket member 4, the axle member 3 is moved vertically along the center axle hole 201 of the holder member 2, avoiding vibration.

When going to fasten the first panel member 6 to the second panel member 7, rotate the finger rod 12 of the base member 1 relative to the socket member 4 to move the curved track 5 at the base member 1 along the curved track 5 at the socket member 4. During rotation of the base member 1 relative to the socket member 4 at this time, the two opposite lifting portions 51 of the curved track 5 at the base member 1 are respectively moved away from the bearing grooves 511 in the opposite lifting portions 51 of the curved track 5 at the socket member 4 along the two sloping guide surfaces 521 of the curved track 5 at the socket member 4 to the homing grooves 52 of the curved track 5 at the base member 1, and the two opposite lifting portions 51 of the curved track 5 at the socket member 4 are moved away from the bearing grooves 511 in the curved track 5 at the base member 1 along the two sloping guide surfaces 521 of the curved track 5 at the base member 1 to the homing grooves 52 of the curved track 5 at the base member 1. At this time, the spring member 32 is released to push the expanded bottom end portion 31 of the axle member 3 downwardly out of the bottom-open chamber 20 of the holder member 2 and engaged into the locking hole 70 of the second panel member 7 to lock the first panel member 6 to the second panel member 7. Because the socket member 4 is moved with the curved track 5 at the socket member 4 along the curved track 5 at the base member 1 when lowering the axle member 3, the socket member 4 will not be forced to strike against the base member 1 when the spring member 32 pushes the axle member 3 downwardly from the unlocking position to the locking position to lock the first panel member 6 to the second panel member 7.

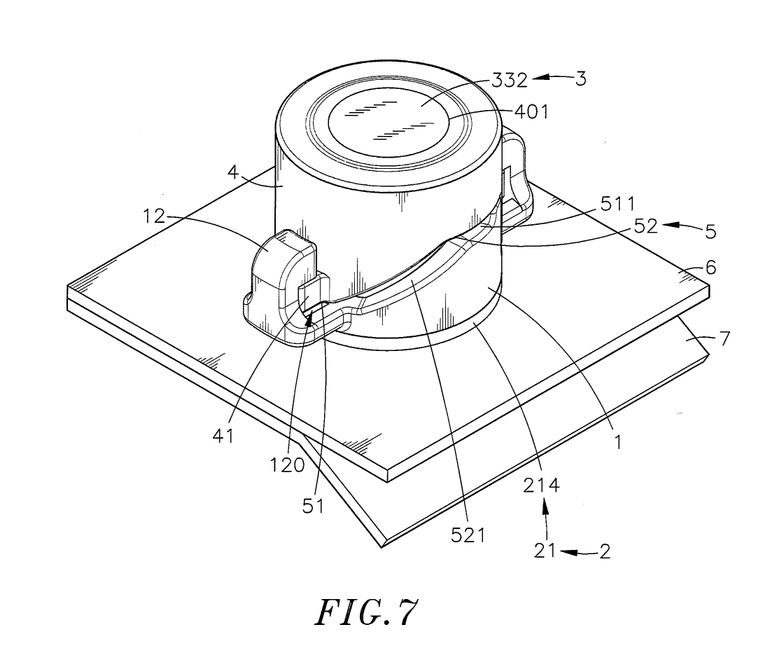

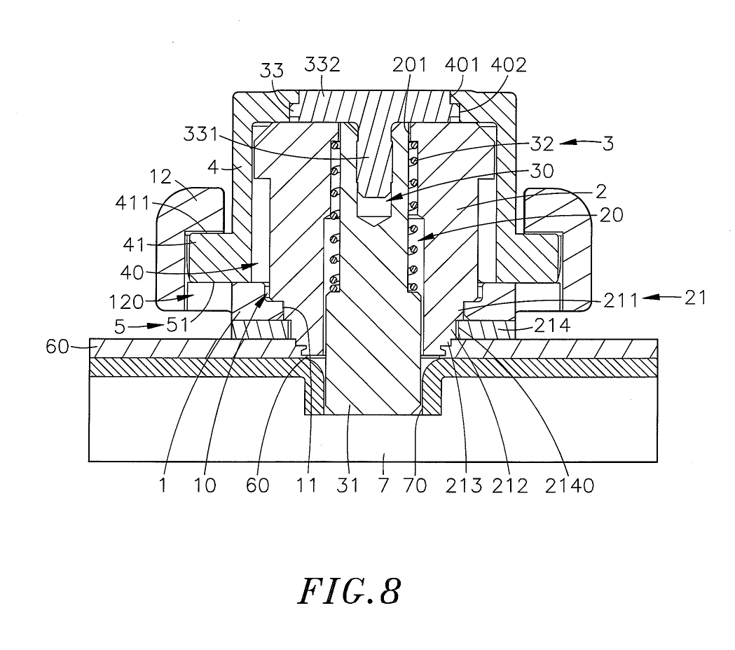

Referring to FIGS. 7 and 8, a rotary fastener in accordance with a second embodiment of the present invention is shown. This second embodiment is substantially similar to the aforesaid first embodiment with the exception that the socket member 4 comprises two locating blocks 41 respectively perpendicularly extended from the periphery thereof at two opposite sides; the base member 1 comprises two finger rods 12 of inverted L-shaped profile extended from the periphery thereof at two opposite sides, and a retaining groove 120 defined between each finger rod 12 and the periphery of the base member 1 for the positioning of one respective locating block 41 of the socket member 4. During operation, the user can grasp either finger rod 12 or both the two finger rods 12 with the fingers to rotate the base member 1 with the curved track 5 at the base member 1 along the curved track 5 at the socket member 4, moving the socket member 4, the cap member 33 and the axle member 3 vertically relative to the holder member 2 between the locking position to lock the first panel member 6 to the second panel member 7 and the unlocking position to unlock the first panel member 6 from the second panel member 7.

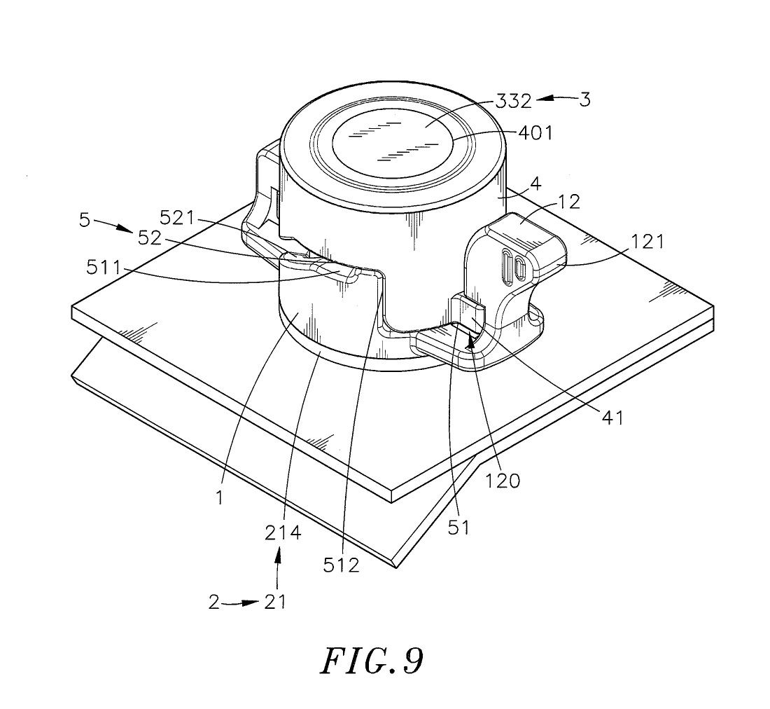

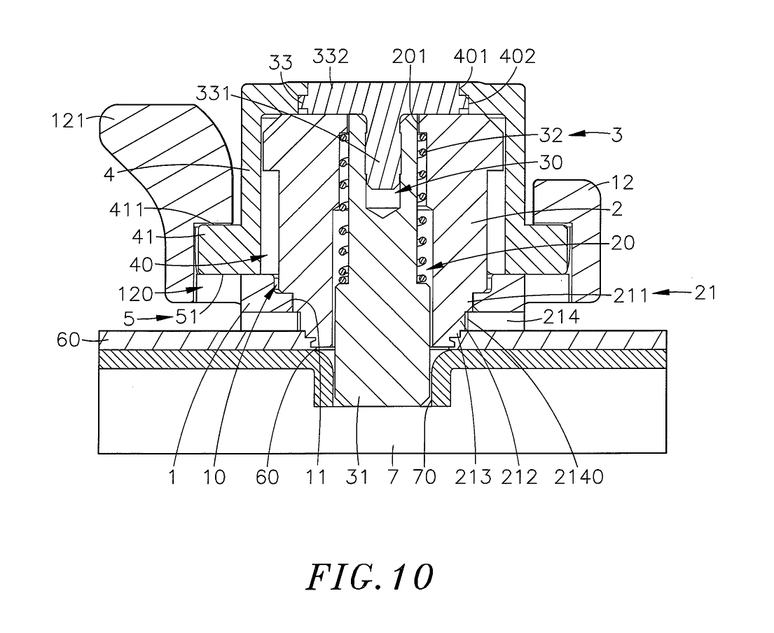

Referring to FIGS. 9 and 10, a rotary fastener in accordance with a third embodiment of the present invention is shown. This third embodiment is substantially similar to the aforesaid first embodiment with the exception that the socket member 4 comprises two locating blocks 41 respectively perpendicularly extended from the periphery thereof at two opposite sides; the base member 1 comprises two finger rods 12 of inverted L-shaped profile extended from the periphery thereof at two opposite sides, and a retaining groove 120 defined between each finger rod 12 and the periphery of the base member 1 for the positioning of one respective locating block 41 of the socket member 4. Further, each inverted L-shaped finger rod 12 has a wing portion 121 formed integral with a top outer part thereof to increase the area for the grasping of the fingers. During operation, the user can grasp the wing portion 121 of either finger rod 12 or each of the two finger rods 12 with the fingers to rotate the base member 1 with the curved track 5 at the base member 1 along the curved track 5 at the socket member 4, moving the socket member 4, the cap member 33 and the axle member 3 vertically relative to the holder member 2 between the locking position to lock the first panel member 6 to the second panel member 7 and the unlocking position to unlock the first panel member 6 from the second panel member 7.

In conclusion, the invention provides a rotary fastener, which comprises a base member 1 that comprises an accommodation open chamber 10, an axial center hole 11 cut through a bottom wall thereof in communication with the accommodation open chamber 10, at least one finger rod 12 extended from the periphery thereof and a retaining groove 120 defined between each finger rod 12 and the periphery of the base member 1, a holder member 2 that is mounted in the accommodation open chamber 10 and comprises a bottom-open chamber 20, a center axle hole 201 located in a top wall thereof in communication with the bottom-open chamber 20 and a stepped, tubular bottom mounting neck 21 axially downwardly extended from an opposing bottom edge thereof, an axle member 3 that is movably upwardly inserted through the center axle hole 201 of the holder member 2, having an expanded bottom end portion 31 thereof downwardly movable in and out of the stepped, tubular bottom mounting neck 21 of the holder member 2, a spring member 32 sleeved onto the axle member 3 and stopped between the expanded bottom end portion 31 of the axle member 3 and an inner surface of the top wall of the holder member 2, a cap member 33 affixed to the top end of the axle member 3 above the holder member 2, a socket member 4 that is affixed to the cap member 33 and rotatably and axially movably disposed around the holder member 2 and comprises at least one locating block 41 perpendicularly extended from the periphery thereof and respectively engageable in the retaining groove 120 in each finger rod 12 of the base member 1, and two mating curved tracks 5 that are respectively located at the top side of the base member 1 and the bottom side of the socket member 4 and matched with each other for enabling the axle member 3 to be moved vertically up and down between a locking position and an unlocking position upon rotation of the base member 1 relative to the socket member 4.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A rotary fastener installed in a mounting through hole of a first panel member and adapted for detachably locking said first panel member to a locking hole of a second panel member, the rotary fastener comprising:
a base member comprising an accommodation open chamber, an axial center hole cut through a bottom wall thereof in communication with said accommodation open chamber, at least one finger rod extended from the periphery thereof, and a retaining groove defined between each said finger rod and the periphery of said base member;
a holder member mounted in said accommodation open chamber of said base member, said holder member comprising a bottom-open chamber, a center axle hole located in a top wall thereof in communication with said bottom-open chamber, and a stepped, tubular bottom mounting neck axially downwardly extended from an opposing bottom edge thereof and fastened to said axial center hole of said base member;
an axle member upwardly inserted through said center axle hole of said holder member and vertically movable in and out of said stepped, tubular bottom mounting neck of said holder member and into or away from said locking hole of said second panel member between a locking position to lock said first panel member to said second panel member and an unlocking position to unlock said first panel member from said second panel member, said axle member comprising a mounting hole located in a top end thereof;
a spring member sleeved onto said axle member and stopped between said expanded bottom end portion of said axle member and an inner surface of the top wall of said holder member;
a cap member comprising a bottom mounting rod downwardly extended from a bottom side thereof and affixed to said mounting hole of said axle member and a flat top mounting block located at an opposing top side thereof;
a socket member affixed to said cap member above said holder member, said socket member comprising a receiving chamber defined therein and extending through a bottom side thereof, a top opening located in an opposing top side thereof in communication with said receiving chamber and fixedly fastened to said flat top mounting block of said cap member, a mounting groove defined in a top side of said receiving chamber and extending around said top opening and fixedly fastened to the periphery of said cap member, and at least one locating block perpendicularly extended from the periphery thereof and respectively detachably positioned in the retaining groove in each said finger rod of said base member; and
two mating curved tracks respectively formed integral with a part of said base member and a part of said socket member and matched with each other and movable relative to each other to shift said axle member vertically up and down with said cap member between said locking position and said unlocking position upon rotation of said base member relative to said socket member.

2. The rotary fastener as claimed in claim 1, wherein said base member comprises two said finger rods symmetrically disposed at two opposite sides, said finger rods having an inverted L-shaped profile.

3. The rotary fastener as claimed in claim 1, wherein said stepped, tubular bottom mounting neck of said holder member has a cushion ring attached thereto, said stepped, tubular bottom mounting neck comprising an upper coupling ring portion affixed to said axial center hole of said base member, a lower mating connection ring portion affixed to said mounting through hole of said first panel member, and an intermediate engagement ring portion connected between said upper coupling ring portion and said lower mating connection ring portion, said cushion ring being mounted around said intermediate engagement ring portion and stopped between said base member and said first panel member.

4. The rotary fastener as claimed in claim 1, wherein said axle member comprises an expanded bottom end portion located at an opposing bottom end thereof for press-fitting into said locking hole of said second panel member.

5. The rotary fastener as claimed in claim 1, wherein each said locating block of said socket member comprises a rib located at a top side thereof, said rib having an arched cross section.

6. The rotary fastener as claimed in claim 1, wherein each said curved track comprises two opposite lifting portions, two homing grooves equiangularly spaced between said lifting portions at two opposite sides, two sloping guide surfaces respectively downwardly extended from respective one ends of said lifting portions to respective one ends of said homing grooves, and two upright stop edges respectively connected between respective opposite ends of said lifting portions and respective opposite ends of said sloping guide surfaces.

7. The rotary fastener as claimed in claim 6, wherein each said curved track further comprises a bearing groove located in each said lifting portion.
